(19) United States
(12) Patent Application Publication
(10) Pub. No.: US 2006/0038134 A1
(43) Pub. Date: Feb. 23, 2006

(54) Radiographic intensifying screen

(75) Inventors: Katsuhiro Kohda, Kanagawa (JP); Satoshi Kubota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/147,174

(22) Filed: Jun. 8, 2005

(30) Foreign Application Priority Data
Jun. 8, 2004 (JP) 2004-170124

(51) Int. Cl. G21K 4/00

(52) U.S. Cl. 250/483.1

(57) ABSTRACT

A radiographic intensifying screen has a radiographic intensifying function layer in which the radiographic intensifying function layer is composed of a binder and radiographic intensifying particles, in which the intensifying particles is capable of absorbing a radiation and then not emitting a light in ultraviolet or visible wavelength region but emitting secondary electrons, secondary X-rays, secondary γ-rays or their combinations, and the particles contain at least one metal or metal compound in which the metal is gold, tungsten, tantalum, barium, tin, silver, molybdenum, niobium, zirconium, zinc, copper, nickel, cobalt, iron, chromium, vanadium, or titanium.

### FIELD OF THE INVENTION

The present invention relates to a radiographic intensifying screen.

### BACKGROUND OF THE INVENTION

The radiation image-forming method, in which a radiographic intensifying screen (radiographic intensifying sheet) is used in combination with a radiographic film, has been hitherto adopted in radiographic medical diagnosis and industrial radiographic inspection such as non-destructive inspection. In the method, the screen is placed on one or both surface of the radiographic film, which is then exposed to radiation such as X-rays, γ-rays or electron beams having passed through an object or having radiated from an object, so that an image is formed on the film.

In the industrial non-destructive inspection, radiation of high energy such as X-rays or γ-rays is applied to an object (sample) and an image according to spatial energy distribution of the radiation passed through the object is visualized on an industrial radiographic film to examine inner structure of the object or to check defects of the object. The object generally is so thick that an intensifying screen having as high intensifying efficiency as possible is used so as to shorten the exposure time or to lower the radiation dose in the inspection.

The industrial radiographic film is sometimes placed at a short distance from the object so that the radiation passed through the object may not form a blurry image on the film. In that case, the film generally is postured parallel to the outer surface of the object. Accordingly, the radiographic intensifying screen is required to be flexible, and a cassette in which the film and the screen are encased is often made of flexible material such as plastics, rubber or black paper.

In the above-described industrial non-destructive inspection, an intensifying screen in which a metal sheet such as tin foil is provided on a support is often used (see, “Handbook of Non-Destructive Inspection, new edition (Japanese)”, written by The Japanese Society for Non-Destructive Inspection (JSNDI), published by Nikkan Kogyou Shinbun, Ltd., 1978, pp. 275-276). The metal sheet such as tin foil intensifies high-energy radiation well, impairs image quality little, and is relatively flexible. In particular, lead foil remarkably intensifies the radiation, and is flexible and relatively inexpensive.

However, since it is possible that lead metal causes environmental pollution, it is necessary to take good care in disposing of waste lead and, in some countries, the use of lead will be restricted. In addition, the intensifying screen comprising lead foil is flexible but liable to cause plastic deformation when it is used repeatedly.

ASTM STANDARD SECTION 3, E94 discloses a radiographic intensifying screen for industrial radiographic inspection. In the publication, copper, gold, tantalum and lead oxide as well as lead foil are described as materials for the intensifying screen.

### SUMMARY OF THE INVENTION

An object of the present invention is to provide a radiographic intensifying screen having high intensifying efficiency and excellent flexibility but causing no environmental problem.

The present inventors have found that a radiographic intensifying screen suitable for high energy radiation used in industrial radiographic inspection can be obtained if the radiographic intensifying function layer is made of a binder and therein-dispersed fine particles of metal and/or metal compounds (such as tungsten and/or compounds thereof) having good intensifying efficiency.

The present invention resides in a radiographic intensifying screen comprising at least one radiographic intensifying function layer, wherein the radiographic intensifying function layer comprises a binder and radiographic intensifying particles, the radiographic intensifying particles being capable of absorbing a radiation and then not emitting a light in ultraviolet or visible wavelength region but emitting secondary electrons, secondary X-rays, secondary γ-rays or combinations thereof, the particles comprising at least one metal or metal compound, the metal being selected from the group consisting of gold, tungsten, tantalum, barium, tin, silver, molybdenum, niobium, zirconium, zinc, copper, nickel, cobalt, iron, chromium, vanadium, and titanium.

The invention further resides in a radiation image-forming method comprising the steps of: combining a radiographic film and the radiographic intensifying screen of the invention to give a combined body; and irradiating the combined body with radiation having passed through an object, having been diffracted or scattered by an object or having radiated from an object, whereby the film is exposed to secondary electrons emitted from the radiographic intensifying function layer of the screen and an image according to spatial energy distribution of the radiation is produced on the film.

The present invention makes it possible to produce a highly effective and flexible radiographic intensifying screen at a relatively small cost. Although effectively intensifying radiation, metals and metal compounds are often expensive or difficult to form into foil. In order to solve this problem, the metals are used in the form of fine particles in the invention. Further, in contrast with a conventional lead foil screen, there is almost no possibility that the intensifying screen of the invention causes environmental pollution. Therefore, the radiographic intensifying screen of the invention is advantageously used in radiographic processes with high energy radiation, such as industrial radiographic inspection.

### BRIEF DESCRIPTION OF DRAWING

FIG. 1 is a sectional view schematically illustrating a representative structure of the radiographic intensifying screen according to the invention.

FIG. 2 is a sectional view schematically illustrating a representative example (planar box type) of the radiographic cassette according to the invention.

FIG. 3 is a sectional view schematically illustrating another representative example (light-shielding bag type) of the radiographic cassette according to the invention.

FIG. 4 is a sectional view schematically illustrating the radiographic intensifying screen of the invention in contact with a radiographic film.

FIG. 5 is a top plan view n overhead view schematically illustrating a radiographic process according to the radiation image-forming process of the invention.

FIG. 6 is a top plan view schematically illustrating another radiographic process according to the radiation image-forming method of the invention.

### DETAILED DESCRIPTION OF THE INVENTION

Preferred embodiments of the radiographic intensifying screens according to the invention are as follows.

(1) The radiographic intensifying particles contain the metal in an amount of 50 wt. % or more.

(2) A spatial packing ratio of the radiographic intensifying particles in the radiographic intensifying function layer is 40 vol. % or more.

(3) The radiographic intensifying particles comprise simple tungsten metal, a tungsten compound or a mixture thereof.

(4) The binder comprises organic polymer material, and a ratio between the radiographic intensifying particles and the binder (former:latter) is in the range of 10:1 to 100:1 by weight.

(5) The radiographic intensifying particles have a mean size in the range of 0.3 μm to 20 μm.

(6) The radiographic intensifying function layer has a thickness of 5 to 1,000 μm.

(7) The radiographic intensifying screen is an intensifying screen for radiation of high energy.

In the following description, the radiographic intensifying screen of the invention is explained in detail by referring to the attached drawings.

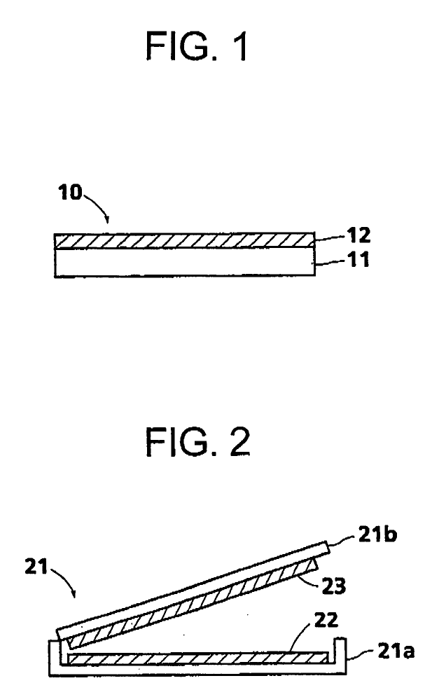

FIG. 1 is a sectional view schematically illustrating a representative structure of the intensifying screen according to the invention. The intensifying screen 10 comprises a support 11 and a radiographic intensifying function layer 12. The function layer 12 comprises a binder and particles intensifying radiation (namely, radiographic intensifying particles) dispersed therein.

In the invention, the radiographic intensifying particles are particles capable of absorbing radiation and emitting secondary electrons, and the particles contain at least one metal selected from the group consisting of gold, tungsten, tantalum, barium, tin, silver, molybdenum, niobium, zirconium, zinc, copper, nickel, cobalt, iron, chromium, vanadium and titanium. The metal may be in the form of a metal compound or a mixture thereof. Examples of the metal compounds include oxides (e.g., tungsten oxides (WO₃, WO₄), molybdenum oxide (MoO₂)), and tungsten carbide (WC). The metal compound and the mixture of metal and metal compound preferably contain the metal in a content of 50 wt. % or more.

In consideration of emitting secondary electrons, metals having large atomic numbers are preferred. Particularly preferred is tungsten. In other words, the radiographic intensifying particles are preferably made of a tungsten metal, tungsten compound (e.g., WO₄) or a mixture thereof. Although it is difficult and accordingly costs much to make tungsten foil, the screen of the invention can be produced at relatively small cost since powdery tungsten is used.

The radiographic intensifying particles preferably have a mean size in the range of 0.3 μm to 20 μm. If the sizes are larger than 20 μm, the resultant radiation image often has such uneven density that the sharpness decreases.

The binder preferably is an organic polymer material in consideration of flexibility. Examples of the organic polymer materials include synthetic polymers such as nitrocellulose, ethyl cellulose, cellulose acetate, polyvinyl butyral, linear polyester, polyvinyl acetate, vinylidene chloride-vinyl chloride copolymer, vinyl chloride-vinyl acetate copolymer, polyalkyl (meth)acrylate, polycarbonate, polyurethane, cellulose acetate butyrate, polyvinyl alcohol and thermoplastic elastomers; and natural polymers such as proteins (e.g., gelatin), polysaccharides (e.g., dextran) and gum arabic. These polymers may be crosslinked with a crosslinking agent.

The spatial packing ratio of the radiographic intensifying particles in the intensifying function layer 12 generally is 40 vol. % or more, preferably 60 vol. % or more. A ratio between the intensifying particles and the binder (former:latter) in the function layer generally is in the range of 10:1 to 100:1 by weight.

The thickness of the intensifying function layer 12 depends on penetrating power of used radiation, but generally is in the range of 5 to 1,000 μm if the screen is placed on the incident side of the film. If the screen is placed on the opposite (back) side, the thickness of the function layer generally is in the range of 5 to 3,000 μm. In the industrial radiographic method, the function layer of the screen on the back side is generally thicker than that on the incident side. Further, if placed on the incident side, the screen having too thick a function layer absorbs radiation too much and accordingly lowers the intensifying efficiency.

Since the radiographic intensifying screen has an intensifying function layer made of a binder and intensifying particles, the intensifying screen of the invention is more flexible than a conventional intensifying screen comprising metal foil. Accordingly, in a radiographic method, the intensifying screen of the invention can be easily deformed (or curved) parallel to the outer surface of the object. Further, the intensifying screen of the invention can be well in contact with a radiographic film, and accordingly the surface of the intensifying screen is resistant to scratch.

The radiographic intensifying screen of the invention is not restricted to FIG. 1, and can have various auxiliary layers described later such as a protective layer.

The radiographic intensifying screen of the invention can be produced, for example, in the following manner.

The support generally is a flexible sheet or film having a thickness of 50 μm to 1 mm. Examples of materials for the support include resins such as polyethylene terephthalate, polycarbonate, polyethylene naphthalate, acrylic resin, vinyl chloride resin, polyethylene and polyurethane; baryta paper; resin-coated paper; ordinary paper; wood; and metals and alloys such as iron and aluminum. On the support surface on which the intensifying function layer is to be provided, auxiliary layers such as a subbing layer and an electro-conductive layer can be formed. Further, many fine concaves and convexes can be formed on the surface of the support.

On the support, the radiographic intensifying function layer comprising radiographic intensifying particles is provided. For forming the intensifying function layer, the intensifying particles and the binder are dispersed or dissolved in an appropriate organic solvent to prepare a coating dispersion. A ratio between the particles and the binder in the solution generally is in the range of 10:1 to 100:1 (by weight), preferably in the range of 10:1 to 50:1 (by weight).

Examples of the solvent include lower aliphatic alcohols, chlorinated hydrocarbons, ketones, esters, ethers, and mixtures thereof.

The coating dispersion can contain various additives such as a dispersing agent, a plasticizer for enhancing bonding between the binder and the particles, an anti-yellowing agent for preventing the function layer from undesirable coloring, a hardening agent, and a crosslinking agent.

The prepared coating dispersion is then evenly spread on a surface of the support by means of coating means, and dried to form the radiographic intensifying function layer.

The thickness of the intensifying function layer is determined according to various conditions such as characteristics of the desired intensifying screen, properties of the intensifying particles and the mixing ratio between the binder and the particles, but generally is in the range of 5 to 1,000 μm, preferably in the range of 10 to 500 μm.

Thus produced intensifying function layer can be compressed by means of, for example, a calendering machine so that the packing ratio of the intensifying particles in the layer can be further increased.

The intensifying function layer does not always need to be a single layer, and may consist of two or more sublayers. In that case, the sub-layers can differ in the intensifying particles in regard to the component or the particle size or in the ratio between the particles and the binder. The ratio can be optionally determined. Further, it is not necessary to form the intensifying function layer directly on the support. For example, the function layer beforehand formed on another substrate (temporary support) may be peeled off and then fixed on the support (or on an auxiliary layer) with an adhesive.

On the intensifying function layer, a protective layer is preferably provided to ensure good handling of the intensifying screen in transportation and to avoid deterioration. Preferably, the protective layer is chemically stable, physically strong, and of high moisture proof for protecting the screen from chemical deterioration and physical damage.

The protective layer can be provided by coating the intensifying function layer with a solution in which a transparent organic polymer is dissolved in an appropriate solvent, by placing a beforehand prepared organic polymer film as the protective sheet on the intensifying function layer with an adhesive, or by depositing vapor of inorganic compounds on the function layer. Various additives can be contained in the protective layer. Examples of the additives include a slipping agent (e.g., powders of perfluoroolefin resin and silicone resin) and a crosslinking agent (e.g., polyisocyanate). The thickness of the protective layer is generally in the range of 1 to 20 μm, preferably in the range of 1 to 7 μm.

For enhancing the resistance to stain, a fluororesin layer can be provided on the protective layer.

In the way described above, the radiographic intensifying screen of the invention can be produced. The intensifying screen of the invention can be in known various structures.

The radiographic cassette and the radiation image-forming method utilizing the intensifying screen of the invention are explained in detail by referring to the attached drawings.

FIG. 2 is a sectional view schematically illustrating a representative structure (planar box type) of the radiographic cassette. The radiographic cassette 21 consists of a body 21a and a lid 21b, which are partly combined so that the lid 21b can be opened or closed. On the bottom of the body 21a and on the inside surface of the lid 21b, radiographic intensifying screens 22, 23 are fixed or placed, respectively. Each of the intensifying screens 22, 23 has the structure shown in FIG. 1 according to the invention.

The body 21a and the lid 21b of the cassette 21 are made of light-shielding but highly radiation-transmittable material such as aluminum and bakelite.

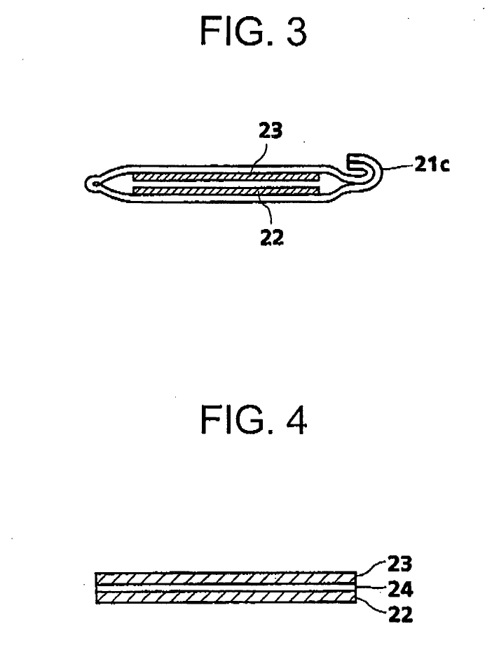

FIG. 3 is a sectional view schematically illustrating another representative structure (light-shielding bag type) of the radiographic cassette. In the light-shielding bag 21c, radiographic intensifying screens 22, 23 are placed as shown in FIG. 3. The opening of the bag 21c is generally closed by folding up as shown in FIG. 3 to prevent light from coming into the bag.

In the radiographic method, a radiographic film 24 is encased in the cassette 21 or 21c. As shown in FIG. 4, in the cassette 21 or 21c, the radiographic film 24 is placed between the intensifying screens 22, 23 so as to keep in contact with them.

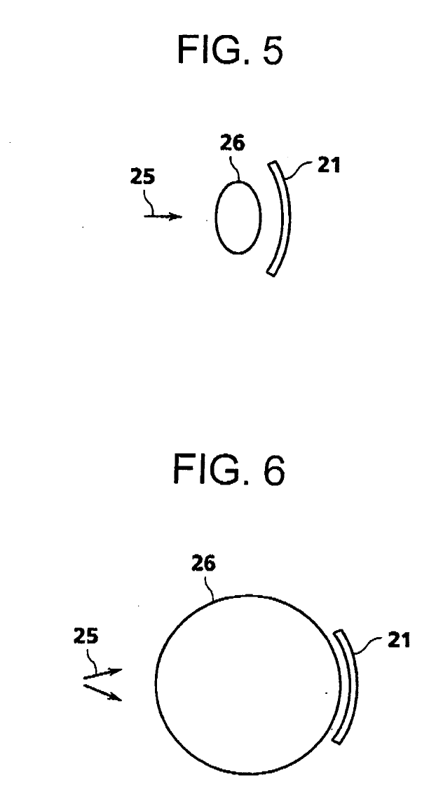

FIGS. 5 and 6 are top views schematically illustrating a radiation image-forming method of the invention. In the method, the cassette 21 containing a radiographic film is deformed to form a curve and placed parallel to the outer surface of the sample (object) 26. With this arrangement kept, the sample 26 is irradiated with radiation 25. The radiation is, for example, X-rays or γ-rays. If the sample 26 by itself emits radiation such as α-rays, γ-rays or electron beams, it is not necessary to irradiate the sample 26 with radiation.

The radiation having passed through the sample 26 comes into the cassette 21 to reach the intensifying screen 22, and is partly absorbed by the intensifying function layer of the intensifying screen 22. The intensifying function layer emits secondary electrons, to which the neighboring radiographic film 24 is exposed. On the other hand, the other portion of radiation still passes through the screen 22 and the film 24 to reach the back-side intensifying screen 23, and is absorbed by the intensifying function layer of the screen 23. The intensifying function layer of the back-side screen also emits secondary electrons, to which the neighboring radiographic film 24 is again exposed. Further, the radiographic film 24 is directly exposed to the radiation. In this way, an image according to spatial energy distribution of the radiation having passed through the sample is formed on the radiographic film 24.

The radiographic cassette is not restricted to the embodiments described above. For example, shock-absorbing material can be provided between the screen and the casing body and between the screen and the lid so that the radiographic film can be closely in contact with the screens. Otherwise, in the cassette, only one intensifying screen can be placed on the bottom of the body.

The radiation image-forming method of the invention is also not restricted to the embodiments shown in FIG. 5. Various known embodiments can be adopted as long as the intensifying screen of the invention closely in contact with the radiographic film is irradiated with radiation. Accordingly, the image-forming method of the invention can be used in various radiographic processes.

The present invention is further described by the following examples.

### EXAMPLE 1

Fine particles of tungsten metal (radiographic intensifying particles, particle sizes: 1.9 to 7.5 (average: 5.2) μm) and vinyl chloride-vinyl acetate copolymer (binder) were added to ethyl acetate, and mixed and dispersed to prepare a coating dispersion (weight ratio of particles/binder: 50/1). The coating dispersion was then spread on a polyethylene terephthalate sheet (support, thickness: 250 μm) by means of a coating machine, and dried to form a radiographic intensifying function layer (thickness: 32 μm). Thus, a radiographic intensifying screen of the invention comprising the support and the intensifying function layer (shown in FIG. 1) was produced.

### EXAMPLES 2 TO 12

The procedure of Example 1 was repeated except for changing the sizes of intensifying particles, the weight ratio between the particles and the binder and/or the thickness of intensifying function layer into those set forth in Table 1, to produce radiographic intensifying screens of the invention.

### COMPARISON EXAMPLES 1 AND 2

The procedure of Example 1 was repeated except that the intensifying function layer was replaced with a sheet of lead foil (whose thickness is set forth in Table 1) fixed with an adhesive on the support, to produce conventional radiographic intensifying screens.

TABLE 1

| Ex. | Intensifying material | Particle sizes¹⁾ (μm) |
|---|---|---|
| Ex. 1 | Fine particles of W | 1.9-7.5 (average: 5.2) |
| Ex. 2 | Fine particles of W | 1.9-7.5 (average: 5.2) |
| EX. 3 | Fine particles of W | 1.9-7.5 (average: 5.2) |
| EX. 4 | Fine particles of W | 1.9-7.5 (average: 5.2) |
| Ex. 5 | Fine particles of W | 1.9-7.5 (average: 5.2) |
| Ex. 6 | Fine particles of W | 1.9-7.5 (average: 5.2) |
| Ex. 7 | Fine particles of W | 7.6-12 (average: 9.8) |
| Ex. 8 | Fine particles of W | 7.6-12 (average: 9.8) |
| Ex. 9 | Fine particles of W | 7.6-12 (average: 9.8) |
| Ex. 10 | Fine particles of W | 1.7-2.0 (average: 1.9) |
| Ex. 11 | Fine particles of W | 1.7-2.0 (average: 1.9) |
| Ex. 12 | Fine particles of W | 1.7-2.0 (average: 1.9) |
| Com. 1 | Lead foil | — |
| Com. 2 | Lead foil | — |

| | Particles/binder | | Thickness of |
|---|---|---|---|
| Ex. | (by weight) | Packing ratio | the layer |
| Ex. 1 | 50/1 | 66 vol. % | 32 μm |
| Ex. 2 | 50/1 | 66 vol. % | 48 μm |
| Ex. 3 | 50/1 | 66 vol. % | 65 μm |
| Ex. 4 | 20/1 | 55 vol. % | 24 μm |
| Ex. 5 | 20/1 | 55 vol. % | 45 μm |
| Ex. 6 | 20/1 | 55 vol. % | 72 μm |
| Ex. 7 | 50/1 | 64 vol. % | 33 μm |
| Ex. 8 | 50/1 | 64 vol. % | 45 μm |
| Ex. 9 | 50/1 | 64 vol. % | 66 μm |
| Ex. 10 | 50/1 | 66 vol. % | 28 μm |
| Ex. 11 | 50/1 | 66 vol. % | 45 μm |
| Ex. 12 | 50/1 | 66 vol. % | 62 μm |
| Com. 1 | — | — | 30 μm |
| Com. 2 | — | — | 100 μm |

Remarks:
¹⁾Sizes of radiographic intensifying particles

[Evaluation of Radiographic Intensifying Screen]

The radiographic intensifying screen produced in each of the Examples and Comparison Examples was combined with X-ray film, and its intensifying efficiency (film density) was measured. In addition, the flexibility of the screen (namely, whether the screen was broken or not when curved) was evaluated.

(1) Intensifying Efficiency (Film Optical Density)

While the intensifying screen was kept in contact with industrial X-ray film (IX100, Fuji Photo Film Co., Ltd.), the radiographic method was carried out under each following condition (A) to (D). After exposed to radiation, the film was subjected to the standard development treatment to form an image. The transmittance of the film was measured to evaluate how densely the image was formed, and thereby the film optical density was obtained. On the basis of the obtained film optical density, the intensifying efficiency was estimated.

(A): The intensifying screen was placed on the incident-side surface of the film, and exposed to X-rays (200 kv) through a filter of iron plate (thickness: 5 mm).

(B): The intensifying screen was placed on the back-side surface of the film, and exposed to X-rays (200 kv) through a filter of iron plate (thickness: 5 mm).

(C): The intensifying screen was placed on the incident-side surface of the film, and exposed to γ-rays (Co) through a filter of iron plate (thickness: 10 mm).

(D): The intensifying screen was placed on the back-side surface of the film, and exposed to γ-rays (Co) through a filter of iron plate (thickness: 10 mm).

(2) Flexibility

The intensifying screen was deformed to form a curve by hand, to test whether the screen was easily curved or not.

The results are set forth in Table 2. In Table 2, the result when the intensifying screen was not used was also shown by way of reference.

TABLE 1

Intensifying efficiency

| Ex. | (A) | (B) | (C) | (D) | Flexibility |
|---|---|---|---|---|---|
| Ex. 1 | 2.2 | 2.0 | 0.9 | 1.0 | Flexible |
| Ex. 2 | 2.2 | 2.0 | 0.9 | 1.1 | Flexible |
| Ex. 3 | 2.1 | 1.9 | 0.9 | 1.1 | Flexible |
| Ex. 4 | 2.2 | 2.0 | 0.9 | 1.0 | Flexible |
| Ex. 5 | 2.2 | 1.9 | 0.9 | 1.1 | Flexible |
| Ex. 6 | 2.1 | 2.0 | 0.9 | 1.2 | Flexible |
| Ex. 7 | 2.2 | 2.0 | 0.9 | 1.1 | Flexible |
| Ex. 8 | 2.2 | 2.0 | 0.9 | 1.1 | Flexible |
| Ex. 9 | 2.2 | 2.0 | 0.9 | 1.1 | Flexible |
| Ex. 10 | 2.2 | 2.0 | 0.9 | 1.0 | Flexible |
| Ex. 11 | 2.2 | 2.0 | 0.9 | 1.1 | Flexible |
| Ex. 12 | 2.2 | 2.0 | 0.9 | 1.1 | Flexible |
| Com. 1 | 2.1 | 1.9 | 0.9 | 1.1 | Flexible |
| Com. 2 | 1.8 | 1.9 | 0.8 | 1.2 | Flexible |
| Ref. | 1.2 | 1.2 | 0.8 | 0.8 | — |

The results shown in Table 2 clearly indicate that all the radiographic intensifying screens of the invention (Examples 1 to 12) had as high intensifying efficiencies (film densities) as conventional intensifying screens (Comparison Examples 1, 2) comprising lead foil.

In addition, all the intensifying screens of the invention had appropriate flexibility.

### EXAMPLE 13

Fine particles of simple tungsten metal (radiographic intensifying particles, particle sizes: 1.9 to 7.5 (average: 5.2) μm) and polyethylene (binder) were added to ethyl acetate, and mixed and dispersed to prepare a coating solution (weight ratio of particles/binder: 5/1).

The coating solution was then spread to coat a polyethylene terephthalate sheet (support, thickness: 250 μm) by means of a coating machine, and dried to form a radiographic intensifying function layer (thickness: 180 μm).

Thus, a radiographic intensifying screen of the invention comprising the support and the intensifying function layer (shown in FIG. 1) was produced.

The thus-produced intensifying screen was evaluated in the same manner as described above. As a result, it was confirmed that the intensifying screen also had a high intensifying efficiency and excellent flexibility.

What is claimed is:

1. A radiographic intensifying screen comprising at least one radiographic intensifying function layer, wherein the radiographic intensifying function layer comprises a binder and radiographic intensifying particles, the radiographic intensifying particles being capable of absorbing a radiation and then not emitting a light in ultraviolet or visible wavelength region but emitting secondary electrons, secondary X-rays, secondary γ-rays or combinations thereof, the particles comprising at least one metal or metal compound, the metal being selected from the group consisting of gold, tungsten, tantalum, barium, tin, silver, molybdenum, niobium, zirconium, zinc, copper, nickel, cobalt, iron, chromium, vanadium, and titanium.

2. The radiographic intensifying screen of claim 1, wherein the radiographic intensifying particles comprise the metal compound, and the content of the metal in the particles is at least 50 wt. %.

3. The radiographic intensifying screen of claim 1, wherein the radiographic intensifying function layer contains the radiographic intensifying particles in a spatial packing ratio of 40 vol. % or higher.

4. The radiographic intensifying screen of claim 1, wherein the radiographic intensifying particles comprise a tungsten metal, a tungsten compound or a mixture thereof.

5. The radiographic intensifying screen of claim 1, wherein the binder comprises organic polymer material, and a ratio between the radiographic intensifying particles and the binder is in the range of 10:1 to 100:1 by weight.

6. The radiographic intensifying screen of claim 1, wherein the radiographic intensifying particles have a mean particle size in the range of 0.3 μm to 20 μm.

7. The radiographic intensifying screen of claim 1, wherein the radiographic intensifying function layer has a thickness of 5 to 1,000 μm.

8. A radiation image-forming method comprising the steps of: combining a radiographic film and the radiographic intensifying screen of claim 1 to give a combined body; and irradiating the combined body with radiation having passed through an object, having been diffracted or scattered by an object or having radiated from an object, whereby the film is exposed to secondary electrons emitted from the radiographic intensifying function layer of the screen and an image according to spatial energy distribution of the radiation is produced on the film.
